(19) United States
(12) Patent Application Publication
(10) Pub. No.: US 2012/0151858 A1
(43) Pub. Date: Jun. 21, 2012

(54) WINDOW INSERT

(76) Inventor: Michael Friedman, Centerport, NY (US)

(21) Appl. No.: 13/330,054

(22) Filed: Dec. 19, 2011

Related U.S. Application Data
(60) Provisional application No. 61/424,432, filed on Dec. 17, 2010.

(51) Int. Cl. E06B 3/267; E04C 2/20; E06B 3/20

(52) U.S. Cl. 52/309.1; 52/656.5

(57) ABSTRACT

A window insulating insert comprising a rigid PVC frame supporting a window pane, said rigid PVC frame having interior channels, each of which overlaps and supports each of the edges of said window pane, respectively.

### RELATED APPLICATION

The present application claims the benefit of the filing date of Provisional Application No. 61/424,432 filed Dec. 17, 2010.

### BACKGROUND OF THE INVENTION

Various methods have been devised to reduce heat energy transfer at windows of buildings to lower energy costs. With energy costs rising significantly there is strong interest from businesses and individuals to seek ways to keep energy costs in check.

Energy-efficient multi-pane replacement windows are commercially available at significant expense and are effective if properly installed. There is high cost specialized labor skill needed for existing window replacement Lower cost alternatives are available such as plastic sheeting attached with tape or staples. Although labor is required to install and remove them, material cost is low and labor not highly skilled.

Reduced clarity over time, however, is a possible negative as is the need to frequently replace the plastic sheeting to compensate for this

Another method has been the use of window inserts classified as “interior storm windows” which are also installed from the inside, sometimes without disturbing existing permanent windows. They utilize glass or clear semi-rigid plastics such as acrylic sheets. These alternatives may require installation hardware that remains in place when inserts are periodically removed to gain access to open permanently installed windows.

One insert on the market employs thick foam weather stripping attached to the perimeter edges of the insert frame. This acts to seal off air migration and uses the foam's compressibility to keep the insert in position. Sometimes fasteners are used to ensure that the insert won't dislodge when time and seasonal temperature fluctuations cause the weather stripping to lose resiliency. This method is also significantly less costly than that of replacement windows. Magnetic strips are employed in a number of prior patents to attach the insert at an existing window.

Other window inserts incorporate spring tension to provide the compressive force to keep the insert in position such as in U.S. Pat. No. 4,676,024 by Rossman and U.S. Pat. No. 4,841,696 by Miller. The channel-forming legs in the frame segments of my window insert interact with both the acrylic pane and the springs in a novel way which results in fewer parts and thus lower manufacturing costs. The channel-forming legs provide overlapping frictional engagement of the frame segment with the insert pane so when the window insert is carried to the installation point and during installation, the frame segments won't detach from the pane (fall off). The overlapping frictional engagement also provides an effective air-tight seal between the pane and the channel-forming legs requiring no added weather stripping between the pane and legs when my window insert is installed in an existing window frame.

The desired overlapping frictional engagement between the channel-forming legs and acrylic pane is enhanced by the resilient spring-like “memory” of the preferred rigid PVC material that is used to manufacture the frame segments and included channel-forming legs. The initial width of the channel is a suitable amount less than the pane thickness so as to ensure the desired amount of frictional engagement. Suitable radii at the channel opening allow the leading edges of the pane to more easily be inserted in the channel and spread the channel legs to accommodate the pane's greater thickness.

Although the said overlapping frictional engagement forms a said insulating seal and prevents the frame segments from dislodging from the pane before successful installation of the window insert is accomplished, it does not hamper the frame segments to expand and snuggly fit against the permanent window frame surfaces with adequate spring tension to keep the window insert in place.

By designing the channel-forming legs to serve multiple functions, the manufacture and assembly process is simplified with fewer, easy to manufacture parts and results in lower costs.

My insert is designed to be installed and removed in moments without tools or special skills, thereby eliminating professional labor costs. The following section provides specific details and drawings.

### SUMMARY OF THE INVENTION

A window insert that consists of a rigid PVC assembly of frame segments with interior channels that overlap the perimeter sides of an included acrylic window pane; the pane has a thickness of about ⅛″. Each frame segment interior channel is formed by 2 parallel channel-forming legs with a channel width less than ⅛″ prior to insertion of pane. The channel-forming legs extend toward the inner surface of the base of the frame segment for a distance of about ¾″and frictionally overlap both sides of the acrylic pane's perimeter for their length. A suitable number of leaf springs, each about 1″ height×3″ length×⅜″ width are partially deflected when placed in the approximately ¾″ space between the bottom edges of the channel-forming legs and the inner surface of the base of the frame segments. The springs are now under partial compression and tend to remain in their assigned positions in the frame segments. The installer manually compresses the spring-loaded insert frame segments with attached pane (there are usually 4 segments) in a preferred sequence towards the center of the pane to temporarily make the insert marginally smaller than the permanent window frame opening. The insert is placed within said opening, aligned parallel to the existing window and then released so each frame segment independently expands to press snuggly against its' corresponding window frame surface. A hand grip, continuous along the frame segment's length aids in positioning the window insert during installation and for removal.

Weather stripping is attached to the perimeter edges of the window insert frame segments in a T-slot to seal any spaces between the insert frame segments and the permanent window frame. Snap-on-able caps are provided to seal corner spaces. No tools or special skills are required for installation.

### DETAILED DESCRIPTION OF WINDOW INSERT CONSTRUCTION AND OPERATION

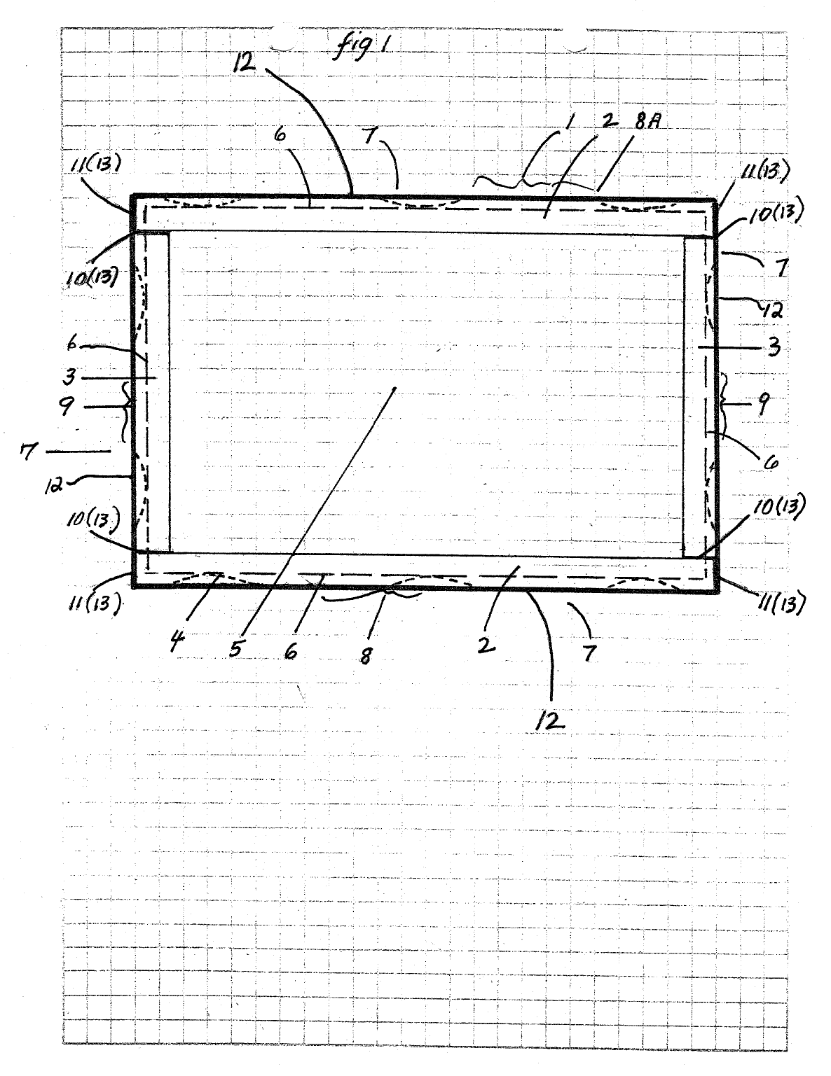

FIG. 1 is a plane view of the window insert installed within the frame of a permanent window with the window insert frame segments spring-loaded against the permanent frame.

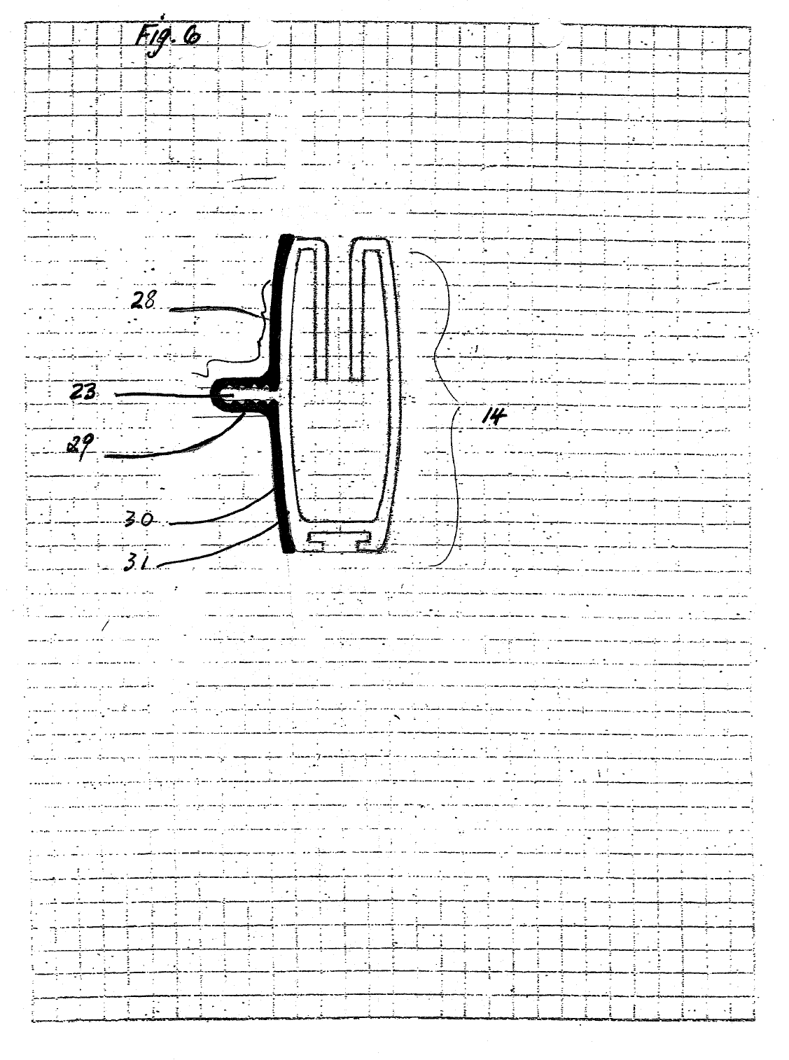

1 is the complete window insert assembly; 2 is the horizontal frame segment of window insert; 3 is the vertical frame segment; 4 is the spring shown in edge profile; 5 is the acrylic window insert pane; 6 is the perimeter edge of pane; 7 is the permanent window frame; 8 is the lower horizontal permanent frame; 8A is the upper horizontal permanent frame; 9 is the vertical permanent window frame; 10 is space between horizontal and vertical frame segments when installed ; 11 is space between ends of horizontal insert frame segments and vertical frame of permanent window ; 12 is weather strip attached to all window insert frame segments to seal at frame of permanent window; 13 is L-shaped weather strip chosen to be bendable, compressible and resilient, to seal spaces 10 & 11 at each insert corner area. A preferred method to seal spaces 10 & 11 are shown in FIGS. 6-8.

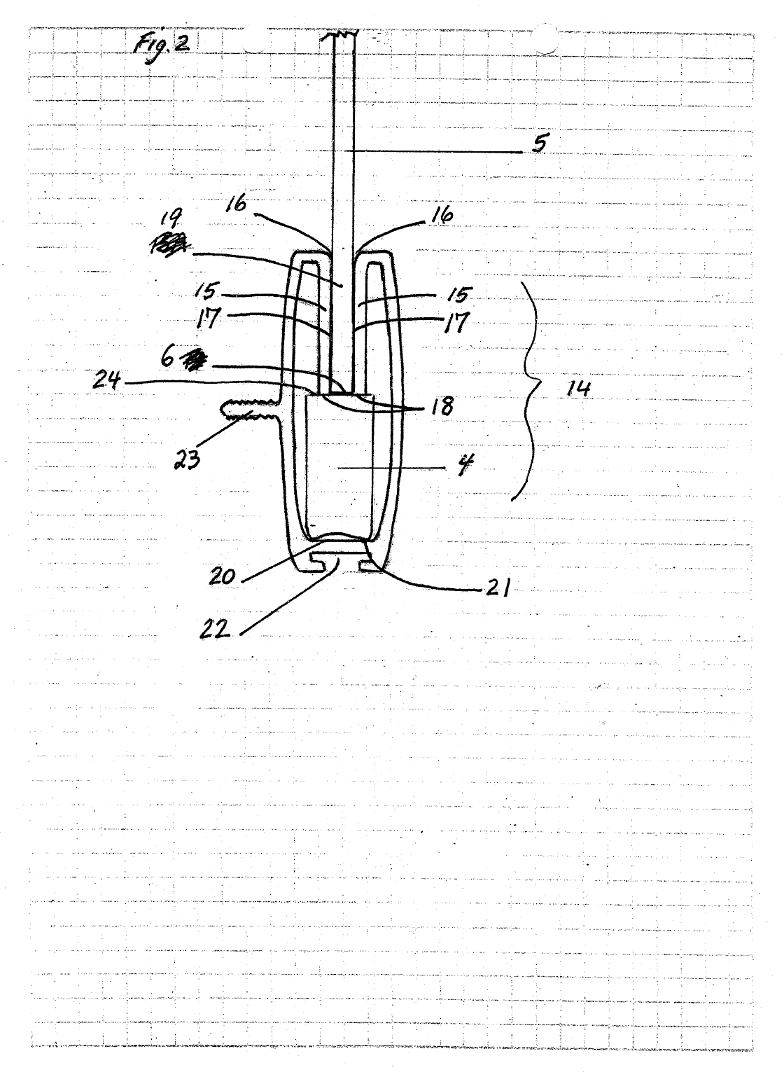

FIG. 2 is across-sectional view of the window insert frame segment assembly showing the leaf spring partially deflected against the tips of the channel-forming legs and the inner surface of the segment base.

14 is cross-sectional view of a window insert frame segment showing spring (4) partially deflected; 15 is one of 2 interior legs of window insert frame which together form a channel (19) to receive the acrylic pane (5); 16 is an inward facing corner with radius at the channel opening to facilitate insertion of acrylic pane into channel; 17 is channel-facing side of channel-forming legs (15); 18 are bottom edges of channel-forming legs against which the spring (4) is in partially deflected, tensioned contact; 24 is the convex-shaped top-most surface of the spring deflected against the bottom edges of the channel-forming legs (18); 20 is the inside surface of the base of the window insert frame segment facing toward the bottom edges (18) of the channel-forming legs; 21 is the base of the spring (4); 22 is a T-slot to receive a weather strip; 23 is a hand grip to facilitate installation and removal of the window insert.

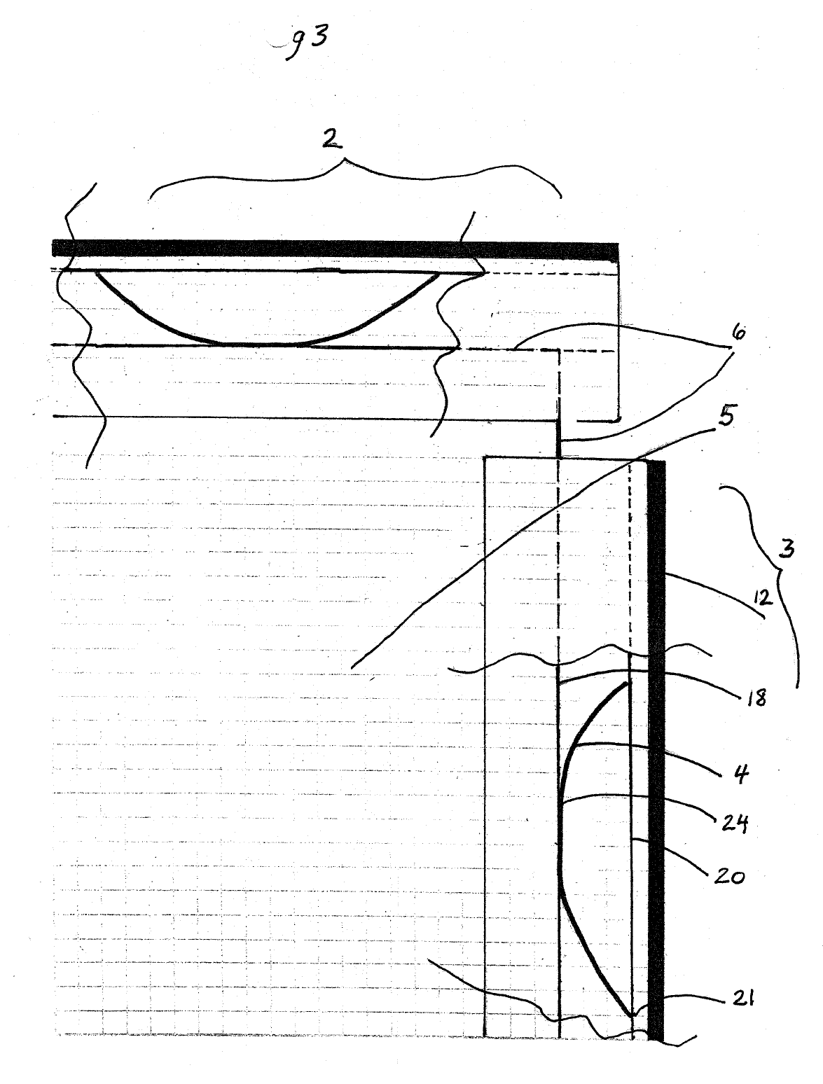

FIG. 3 is a plane view of adjacent window insert frame segments with partially deflected spring prior to installation.

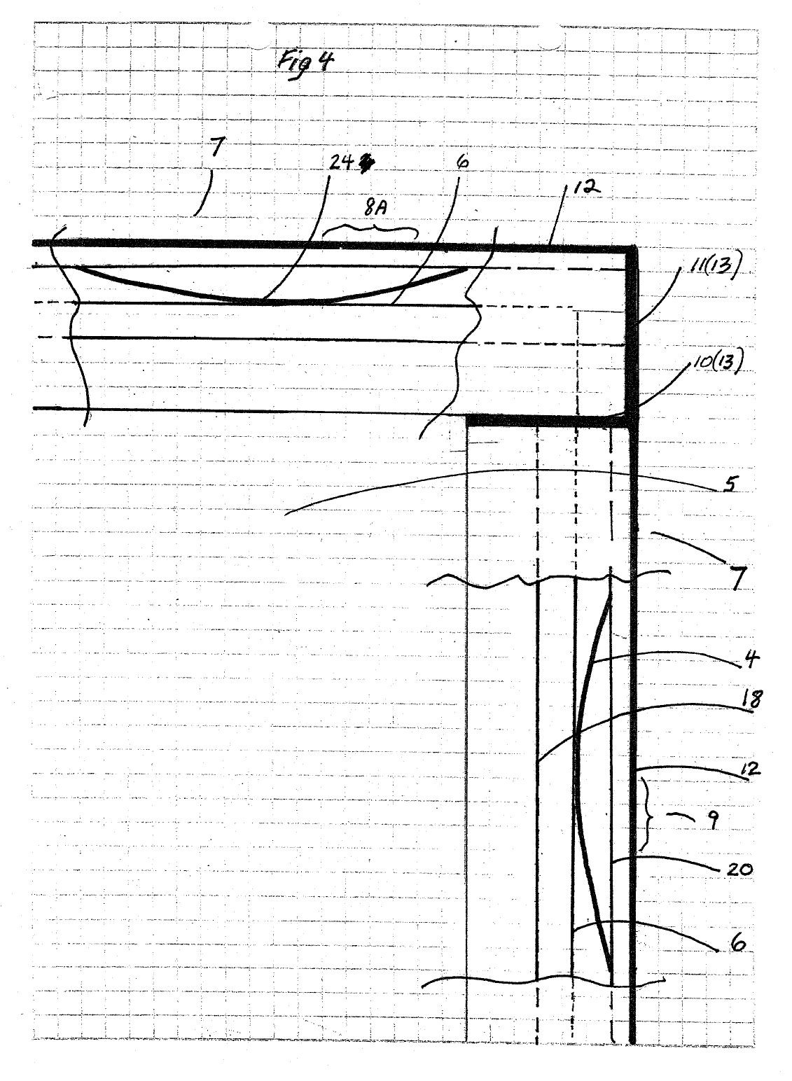

FIG. 4 is a plane view of adjacent window insert frame segments installed in permanent window frame with edge of pane fully deflecting the springs and L-shaped weather stripping applied to corner vicinity.

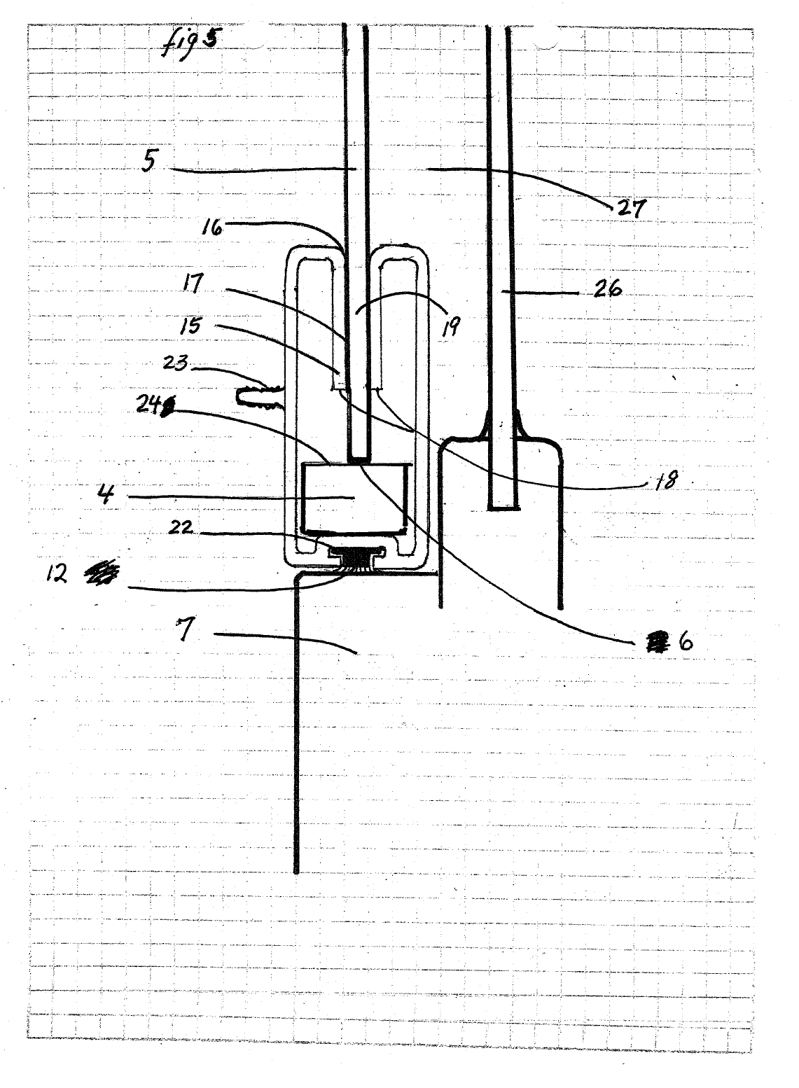

24 is the convex-shaped portion of spring deflected by perimeter edge of pane. FIG. 5 is a cross-sectional view of installed window insert with spring fully deflected. 12 is perimeter weather strip in T-slot (22); 26 is pane of existing window; 27 is sealed space between existing permanent window and window insert.

FIG. 6 is a cross-sectional view of the window frame segment (14) with cap extrusion (28) fastened to the hand grip (23) of frame segments at each corner of the window frame insert using ribs on both the hand grip (23) and corresponding surfaces of the cap extrusion that are designed to interlock. Each wing (30) of the cap extrusion is in contact with its corresponding side (31) of the frame segment. 29 is the outside surface of the cap extrusion that is grasped to slide the cap extrusion along the frame segments (2, 3) to seal corner spaces (10, 11)

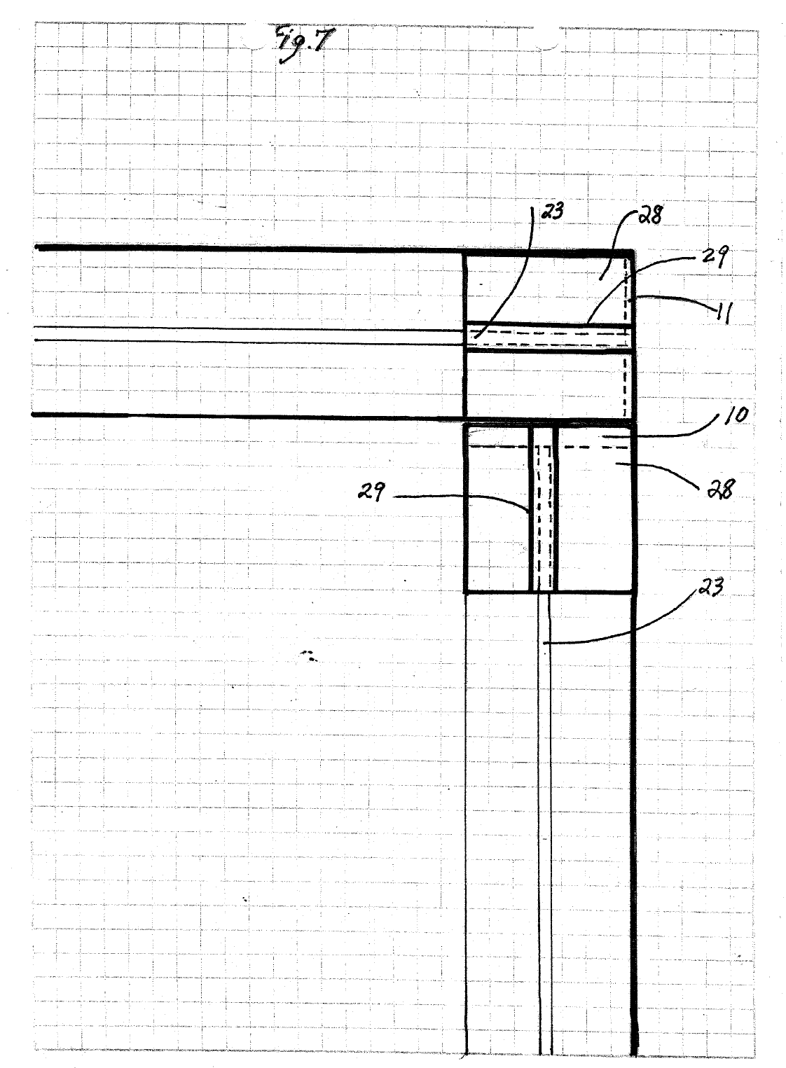

As is shown in FIG. 7, two cap extrusions (28) are employed near the corners of the window insert to seal off spaces 10 & 11. This is accomplished by sliding them along the frame segments until they cover the said spaces. The cap extrusions are a preferred addition to the previously described L-shaped weather strip method to seal spaces 10 & 11.

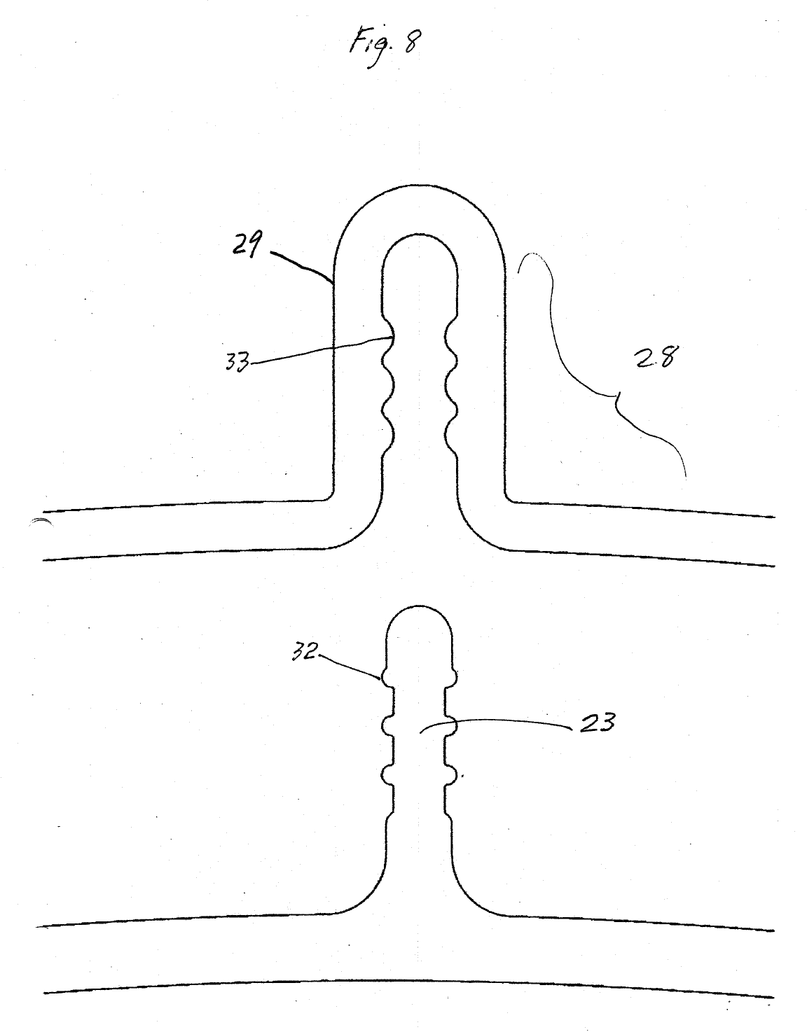

FIG. 8 shows an enlarged cross-sectional view of the ribs (32) of the hand grip of the window insert frame and the corresponding mating surfaces (33) of the cap extrusion designed to interlock with the ribs (32).

It is clear from the foregoing that the window insert of the present invention creates an insulated space at existing windows to slow heat transfer between inside and outside of buildings. It stops chilly drafts and lowers condensation build-up on windows in winter. It permits rooms to stay cooler in the summer. And, it reduces noise pollution.

Further it allows the homeowner to save money by lowering energy bills by reducing the energy used to heat and cool your home or office. It eliminates costly and disruptive installations. The innovative design uses fewer parts thereby providing for a lower cost. Using the inventive window insert yields instant comfort and produces savings that will continue even after replacing windows in the future, with the bonus of helping preserve the environment and reduce the need for foreign fuels.

The process of installing the inventive window insert comprises the following steps: measuring the permanent window frames on windows wherein the window insert will be installed to make sure that the window insert has the right dimensions; resting the lower insert frame segment on the lower horizontal permanent window frame surface, while at the same time, positioning one of the vertical insert frame segments against its corresponding permanent window frame surface; pushing against the opposite vertical insert frame segment, compressing the insert so it fits into the window frame; pushing down on the upper insert segment and pressing it into the upper window frame; and when the insert frame segments are fully seated in the window frame next to the existing window, sliding the two cap extrusions located at each corner to seal any gaps.

While particular embodiments of the invention have been illustrated and described in detail herein, they are provided by way of illustration only and should not be construed to limit the invention. Since certain changes may be made without departing from the scope of the present invention, it is intended that all matter contained in the above description, or shown in the accompanying drawings be interpreted as illustrative and not in a literal sense. Practitioners of the art will realize that the sequence of steps and the embodiments depicted in the figures can be altered without departing from the scope of the present invention and that the illustrations contained herein are singular examples of a multitude of possible depictions of the present invention.

Accordingly, we claim:

1. A window insulating insert comprising a rigid PVC frame supporting a window pane, said rigid PVC frame having interior channels, each of which overlaps and supports each of the edges of said window pane, respectively.

2. The window insulating insert of claim 1 wherein the window pane has a thickness of about ⅛″.

3. The window insulating insert of claim 1, wherein the window pane is acrylic.

4. The window insulting insert of claim 2, wherein the window pane is acrylic.

5. The window insulating insert of claim 1, wherein each frame segment comprises a base and an interior channel formed by two parallel channel-forming legs extending toward the inner surface of the base of said frame segment and frictionally overlapping both sides of the window pane's edges along their entire length.
